(19) United States
(12) Patent Application Publication
(10) Pub. No.: US 2023/0139957 A1
(43) Pub. Date: May 4, 2023

(54) AUTOMATED VISUAL RECOGNITION FOR ATMOSPHERIC VISIBILITY MEASUREMENT

(71) Applicant: Bright Sky Technology Co., Ltd., (US)

(72) Inventors: Chak Wa Cheang, San Mateo, CA (US); Chan Seng Wong, Taipa (MO)

(21) Appl. No.: 17/978,044

(22) Filed: Oct. 31, 2022

Related U.S. Application Data
(60) Provisional application No. 63/274,007, filed on Oct. 31, 2021.

(51) Int. Cl. G06V 10/74; G06V 10/56; G06T 3/60; G06T 7/00; G06T 7/70

(52) U.S. Cl. CPC G06V 10/761; G06V 10/56; G06T 3/60; G06T 7/0002; G06T 7/70; G06V 2201/07; G06T 2207/20132

(57) ABSTRACT

Methods and systems provide for automated visual recognition for atmospheric visibility measurement. First, the method selects and processes one or more images and/or videos with a sufficiently high level of visibility. Second, the method receives manually inputted distance and position data of each target object. The method employs a machine learning model which is trained to recognize objects in the image(s) or video(s). The method then uses the trained model to recognize objects in the image(s) or video(s). For each target object, the method determines whether the target object is recognized in the image(s) or video(s). If the target object is recognized in an image or video, the method determines that the visibility distance in that image or video reaches the distance of the target object. If the target object is not recognized in an image or video, the method determines that visibility distance in that image or video is lower than the distance of the target object.

### CROSS-REFERENCE TO RELATED APPLICATIONS

This application claims the benefit of U.S. provisional application No. 63/274,007, filed on Oct. 31, 2021, the entirety of which is incorporated herein by reference.

### FIELD OF INVENTION

The present invention relates to meteorological prediction. More particularly, the invention relates to providing automated visual recognition for measuring atmospheric visibility distance.

### BACKGROUND

Visibility is closely related to our daily lives and activity. Fog, haze, rain, and sandstorm are some of the causes that lead to low visibility and significantly impact the safety and efficiency of aviation, navigation, driving, logistics, and our daily lives. The impact will be more significant as the global economy grows.

Atmospheric visibility can be defined as a measure of the distance, under the current weather conditions, at which an object or light can be clearly discerned by a human with normal vision under current weather conditions. Manual observation typically focuses on and targets black objects during daytime and lights during nighttime. During manual observation, observers use their eyes, together with experience, to determine visibility. While such observation is convenient and simple to perform, there are significant downsides. The results are purely based on subjective judgment, and are prone to a high error rate and low precision. It is also impossible for such observation to be conducted 24 hours a day, 7 days a week.

The development of atmospheric visibility measurement instruments, such as, e.g., forward scattering spectrometers, transmission visibility meters, and Lidar have been used to measure atmospheric visibility with increased accuracy and precision and a lower error rate. However, these instruments are usually only capable of sampling a small area rather than an entire region. They also have a short lifespan, are subject to weather conditions, and require constant maintenance. Further, they require a high operational cost and skilled technicians.

Image analysis methods have recently attempted to sample the imagery characteristics in order to analyze and determine the atmospheric visibility. Existing image analysis methods are typically based on image brightness, contrast, edge gradient, and other characteristics to perform analysis. While having a higher mobility, accuracy, and cost efficiency than instrument measurement, several disadvantages of current methods exist. First, such methods are unable to adopt brightness variation, e.g., during change of brightness between daytime and nighttime. Second, they employ complex and inefficient calculation and information gathering processes, requiring information such as sky brightness, radiometric correction, sun position, camera direction, and focal length information in order to perform estimation of visibility distance. Third, a specific image background is needed to perform image analysis under these methods. For example, a sky background is required to perform image analysis, thus visibility measurement cannot be performed in places where the sky cannot be seen, such as highways. Fourth, such methods are unable to use a black reference object, since black reference objects typically lack a significant contrast effect due to the observation cameras being dark in color.

Therefore, a need exists in the field for atmospheric visibility measurement devices capable of providing a cost efficient, convenient, and adaptive tool that operates a full 24 hours, 7 days per week.

### SUMMARY

Embodiments of the invention herein include systems, methods, devices, and computer readable storage media, each of which is capable of determining the atmospheric visibility in image(s) or video(s).

In one embodiment, the present invention provides an atmospheric visibility measurement method. First, the method selects and processes one or more image(s) and/or video(s) with a sufficiently high level of visibility. Second, the method receives manually inputted distance and position data of each of a number of target objects. The method employs a machine learning model which is trained to recognize objects in the image(s) or video(s). The method then uses the trained model to recognize objects in the image(s) or video(s). For each target object, the method determines whether the target object is recognized in the image(s) or video(s). If the target object is recognized in an image or video, the method determines that the visibility distance in that image or video reaches the distance of the target object. If the target object is not recognized in an image or video, the method determines that the visibility distance in that image or video is lower than the distance of the target object.

In some embodiments, the system determines that the two or more target objects are recognized in an image or video. The system then determines that the visibility distance in the image or video reaches the distance of the recognized target object at the longest distance.

In some embodiments, the system determines the usability of the image or video by, e.g., determining whether the camera lens is clean, determining whether the camera view is free of obstacles, and/or determining whether the camera lens appears blurry. For example, the system may determine that an image or video is not usable if, e.g., there are rain droplets visible in the camera view, camera fog is present on the camera lens, animals are visible in front of the camera, or similar aspects are present. If the system determines that the images(s) or video(s) are not usable, the system will alert the user and stop measuring the visibility.

Further areas of applicability of the present disclosure will become apparent from the detailed description, the claims and the drawings. The detailed description and specific examples are intended for illustration only and are not intended to limit the scope of the disclosure.

### BRIEF DESCRIPTION OF THE DRAWINGS

The present invention relates generally to digital communication, and more particularly, to systems and methods providing for containment of sensitive data within a communication or messaging platform.

The present disclosure will become better understood from the detailed description and the drawings, wherein:

FIG. 1 is a flow chart illustrating an exemplary method that may be performed in some embodiments.

FIG. 2 is a diagram illustrating an exemplary process in which objects and objects' distance are defined and visibility is measured.

FIG. 3 is a diagram illustrating an exemplary computer that may perform processing in some embodiments.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

In some embodiments, the present invention employs artificial intelligence (hereinafter “AI”) techniques and methods, such as machine learning and/or computer vision techniques and methods, to automatically measure the atmospheric visibility of images or videos. The described methods and systems provide a wide variety of advantages over the existing techniques described above, including ease of use, reduction of human error, and sidestepping the limitations of measurement instruments. The described systems and methods also improve the shortcomings of the existing image analysis methods, significantly ameliorating the accuracy, stability, and usability of atmospheric visibility measurement.

I. Exemplary Environments

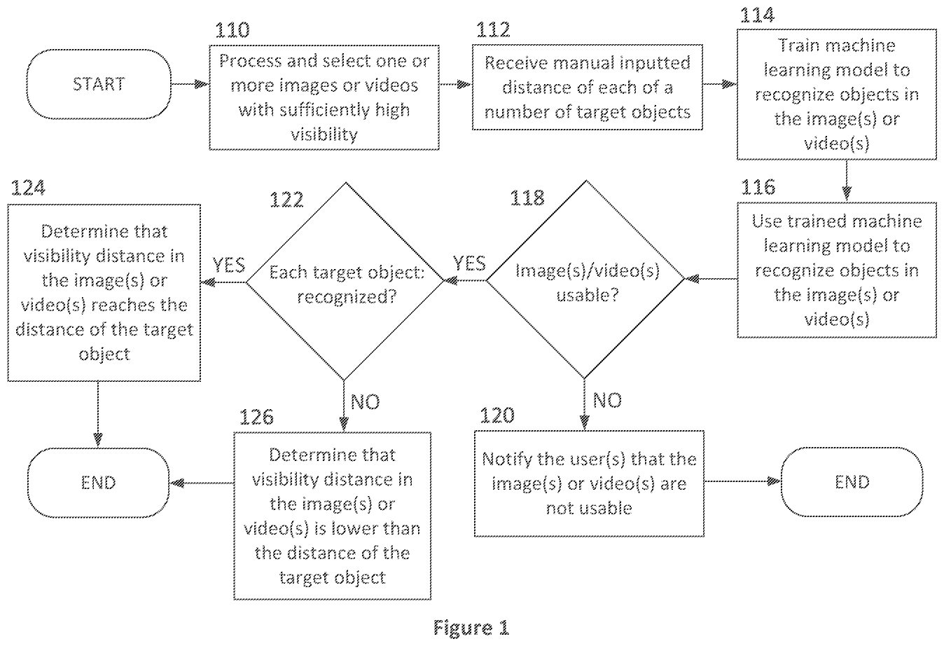

FIG. 1 is a flow chart illustrating an exemplary method that may be performed in some embodiments.

The figure depicts a method to measure atmospheric visibility, including the following steps:

At Step 110, the method selects and processes one or more images and/or videos with a sufficiently high level of visibility.

At Step 112, the method receives manually inputted distance and position data of each target object.

At Step 114, the method employs machine learning techniques to train a machine learning model to recognize objects in the one or more images or videos. In some embodiments, such machine learning techniques may include, e.g., TensorFlow or other suitable machine learning applications or processes.

At step 116, the method uses the trained machine learning model to recognize objects in the one or more images or videos. In some embodiments, this may be achieved through transfer learning or other suitable techniques.

At step 118, the method determines whether the one or more images or videos are usable. In some embodiments, the system determines the usability of the image/video by, e.g., determining whether the camera lens is clean, determining whether the camera view is free of obstacles, and/or determining whether the camera lens appears blurry. For example, the system may determine that an image or video is not usable if, e.g., there are rain droplets visible in the camera view, camera fog is present on the camera lens, animals are visible in front of the camera, or similar aspects are present.

At step 120, the system notifies one or more users that the one or more images or videos are not usable. Once the system determines that the images(s) or video(s) are not usable, the system will alert the user and stop measuring the visibility, presenting an end to the method.

At step 122, for each target object, the method determines whether the target object is recognized in the image(s) or video(s).

At step 124, if the target object is recognized in an image or video, the method determines that the visibility distance in that image or video reaches the distance of the target object, then the method ends.

At step 126, if the target object is not recognized in an image or video, the method determines that the visibility distance in that image or video is lower than the distance of the target object, then the method ends.

In some embodiments, the system determines that the two or more target objects are recognized in an image or video. The system then determines that the visibility distance in the image or video reaches the distance of the recognized target object at the longest distance.

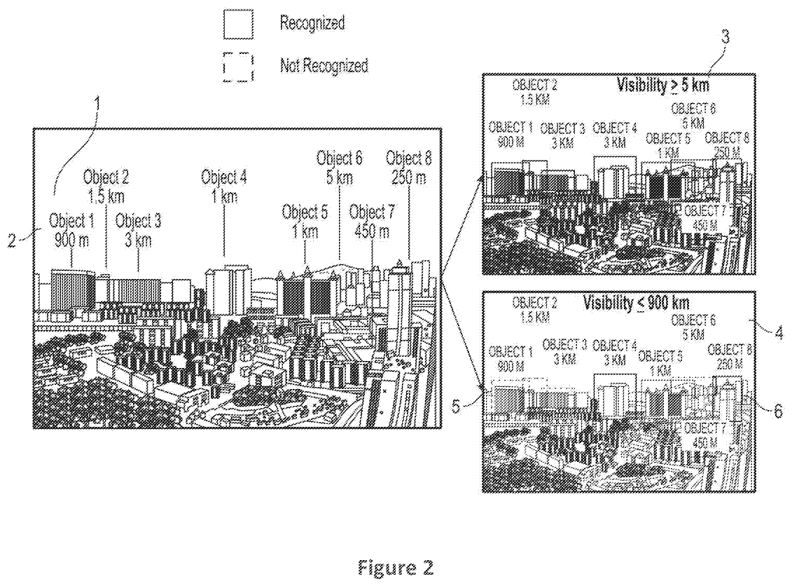

FIG. 2 is a diagram illustrating an exemplary process in which objects and objects' distance are defined and visibility is measured.

The figure depicts the method in which the system measures visibility. 1 is the object name defined by the user. 2 is the distance between the defined object and the camera. The pixels of the defined object will then be the input of a machine learning model. After the training process of the machine learning model, transfer learning is used so that the pre-trained model can be implemented when used. 3 is the visibility determined by the system in step 6. 5 shows the object which has not been recognized in the image(s) or video(s) and thus the visibility is at least lower than the distance between the object and the camera. 6 shows the object being recognized in the image(s) or video(s) and thus the visibility is at least the distance between the camera and that object.

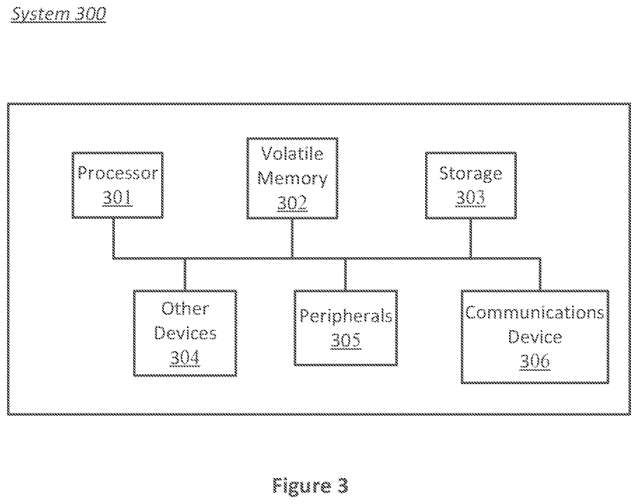

FIG. 3 is a diagram illustrating an exemplary computer that may perform processing in some embodiments. Exemplary computer 300 may perform operations consistent with some embodiments. The architecture of computer 300 is exemplary. Computers can be implemented in a variety of other ways. A wide variety of computers can be used in accordance with the embodiments herein.

Processor 301 may perform computing functions such as running computer programs. The volatile memory 302 may provide temporary storage of data for the processor 301. RAM is one kind of volatile memory. Volatile memory typically requires power to maintain its stored information. Storage 303 provides computer storage for data, instructions, and/or arbitrary information. Non-volatile memory, which can preserve data even when not powered and including disks and flash memory, is an example of storage. Storage 303 may be organized as a file system, database, or in other ways. Data, instructions, and information may be loaded from storage 303 into volatile memory 302 for processing by the processor 301.

The computer 300 may include peripherals 305. Peripherals 305 may include input peripherals such as a keyboard, mouse, trackball, video camera, microphone, and other input devices. Peripherals 305 may also include output devices such as a display. Peripherals 305 may include removable media devices such as CD-R and DVD-R recorders/players. Communications device 306 may connect the computer 100 to an external medium. For example, communications device 306 may take the form of a network adapter that provides communications to a network. A computer 300 may also include a variety of other devices 304. The various components of the computer 300 may be connected by a connection medium such as a bus, crossbar, or network.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A method, comprising:
selecting and processing one or more images or videos with a sufficiently high level of visibility beyond a threshold visibility;
receiving manually inputted distance of each of a plurality of target objects;
training a machine learning model to recognize objects in the one or more images or videos;
recognizing a plurality of objects in the one or more images or videos via the trained machine learning model; and
for each target object:
determining whether the target object is recognized in the one or more images or videos;
if the target object is recognized in an image or video, determining that the visibility distance in the image or video reaches the distance of the target object; and
if the target object is not recognized in an image or video, determining that the visibility distance in the image or video is lower than the distance of the target object.

2. The method of claim 1, further comprising:
determining that two or more target objects are recognized in an image or video; and
determining that the visibility distance in the image or video reaches the distance of the recognized target object at the longest distance.

3. The method of claim 1, further comprising:
prior to training or using the machine learning model, processing the one or more images or videos to apply one or more visual modifications comprising: cropping, shifting, rotating, and altering color of the one or more images or videos.

4. The method of claim 1, further comprising:
receiving the one or more images or videos as a portion of a real-time stream.

5. The method of claim 1, wherein the one or more images or videos have been previously recorded in a prior stream or recording.

6. The method of claim 1, wherein at least one of the plurality of target objects is a landscape.

7. The method of claim 1, further comprising:
determining the usability of the one or more images or videos.

8. The method of claim 7, wherein determining the usability of the one or more images or videos comprises one or more of: determining whether the camera lens is clean, determining whether the camera view is free of obstacles, and determining whether the camera lens appears blurry.

9. The method of claim 7, wherein determining the usability of the one or more images or videos comprises detecting the presence of one or more of: rain droplets, camera fog, and animals in front of the camera.

10. The method of claim 7, further comprising:
upon determining that the one or more images or videos are not usable:
sending an alert to one or more users, and
stopping measurement of visibility.

11. A system comprising one or more processors configured to perform the operations of:
selecting and processing one or more images or videos with a sufficiently high level of visibility beyond a threshold visibility;
receiving manually inputted distance of each of a plurality of target objects;
training a machine learning model to recognize objects in the one or more images or videos;
recognizing a plurality of objects in the one or more images or videos via the trained machine learning model; and
for each target object:
determining whether the target object is recognized in the one or more images or videos;
if the target object is recognized in an image or video, determining that the visibility distance in the image or video reaches the distance of the target object; and
if the target object is not recognized in an image or video, determining that the visibility distance in the image or video is lower than the distance of the target object.

12. The system of claim 1, wherein the one or more processors are further configured to perform the operations of:
determining that two or more target objects are recognized in an image or video; and
determining that the visibility distance in the image or video reaches the distance of the recognized target object at the longest distance.

13. The system of claim 1, wherein the one or more processors are further configured to perform the operation of:
prior to training or using the machine learning model, processing the one or more images or videos to apply one or more visual modifications comprising: cropping, shifting, rotating, and altering color of the one or more images or videos.

14. The system of claim 1, wherein the one or more processors are further configured to perform the operation of:
receiving the one or more images or videos as a portion of a real-time stream.

15. The system of claim 1, wherein the one or more images or videos have been previously recorded in a prior stream or recording.

16. The system of claim 1, wherein at least one of the plurality of target objects is a landscape.

17. The system of claim 1, wherein the one or more processors are further configured to perform the operation of:
determining the usability of the one or more images or videos.

18. The system of claim 17, wherein determining the usability of the one or more images or videos comprises one or more of: determining whether the camera lens is clean, determining whether the camera view is free of obstacles, and determining whether the camera lens appears blurry.

19. The system of claim 17, wherein the one or more processors are further configured to perform the operations of:
upon determining that the one or more images or videos are not usable:
sending an alert to one or more users, and
stopping measurement of visibility.

20. A non-transitory computer-readable medium comprising:
instructions for selecting and processing one or more images or videos with a sufficiently high level of visibility beyond a threshold visibility;
instructions for receiving manually inputted distance of each of a plurality of target objects;
instructions for training a machine learning model to recognize objects in the one or more images or videos;
instructions for recognizing a plurality of objects in the one or more images or videos via the trained machine learning model; and
for each target object:
instructions for determining whether the target object is recognized in the one or more images or videos;
if the target object is recognized in an image or video, instructions for determining that the visibility distance in the image or video reaches the distance of the target object; and
if the target object is not recognized in an image or video, instructions for determining that the visibility distance in the image or video is lower than the distance of the target object.
